(19) United States
(12) Patent Application Publication
(10) Pub. No.: US 2022/0414723 A1
(43) Pub. Date: Dec. 29, 2022

(54) ASSISTANCE SYSTEM, ASSISTANCE METHOD, SERVER DEVICE, AND STORAGE MEDIUM

(71) Applicant: HONDA MOTOR CO., LTD., Tokyo (JP)

(72) Inventors: Koichi TSUNO, Wako-shi (JP); Yasuhiro NAKADA, Wako-shi (JP); Takumi SHIIYAMA, Wako-shi (JP); Tatsuya JINNO, Wako-shi (JP)

(21) Appl. No.: 17/901,832

(22) Filed: Sep. 1, 2022

Related U.S. Application Data
(63) Continuation of application No. PCT/JP2021/009208, filed on Mar. 9, 2021.

(30) Foreign Application Priority Data
Mar. 27, 2020 (JP) 2020-057891

(51) Int. Cl. G06Q 30/02; G06Q 30/06; H01M 10/54; H01M 10/42; H01M 10/48

(52) U.S. Cl. CPC G06Q 30/0284; G06Q 30/0627; H01M 10/54; H01M 10/4221; H01M 10/48

(57) ABSTRACT

The present invention provides an assistance system for assisting with battery reuse, comprising: an acquisition unit configured to acquire, from a user of the battery, time information indicating a scheduled sale timing of the battery, and model information indicating a model and a shape of the battery; a selection unit configured to select a plurality of product types in which the battery can be mounted, based on the model information acquired by the acquisition unit; and a notification unit configured to notify the user of a transaction price of the battery at the scheduled sale timing, for each of the plurality of product types selected by the selection unit, based on the time information acquired by the acquisition unit.

### CROSS-REFERENCE TO RELATED APPLICATION(S)

This application is a continuation of International Patent Application No. PCT/JP2021/009208 filed on Mar. 9, 2021, which claims priority to and the benefit of Japanese Patent Application No. 2020-057891 filed on Mar. 27, 2020, the entire disclosures of which are incorporated herein by reference.

### BACKGROUND OF THE INVENTION

### Field of the Invention

The present invention relates to an assistance system, an assistance method, a server device, and a storage medium for assisting with battery reuse.

### Description of the Related Art

International Publication No. 2015/012144 discloses a system that determines a secondary use destination (another vehicle or a stationary facility) of an in-vehicle battery currently mounted in a target vehicle based on deterioration information of the in-vehicle battery in use.

A user of a battery may want to know how much a transaction price of the battery is when the battery is scheduled to be sold.

### SUMMARY OF THE INVENTION

The present invention provides, for example, an advantageous technique for realizing a desire of a user to know a transaction price of a battery.

According to the present invention, there is provided an assistance system for assisting with battery reuse, comprising: an acquisition unit configured to acquire, from a user of the battery, time information indicating a scheduled sale timing of the battery, and model information indicating a model and a shape of the battery; a selection unit configured to select a plurality of product types in which the battery can be mounted, based on the model information acquired by the acquisition unit; a notification unit configured to notify the user of a transaction price of the battery at the scheduled sale timing, for each of the plurality of product types selected by the selection unit, based on the time information acquired by the acquisition unit; and a providing unit configured to provide the user with usage method information on a usage method of the battery for reducing deterioration of the battery until the scheduled sale timing, with a product type selected among the plurality of product types by the user in response to notification of the transaction price by the notification unit as a target of a reuse destination, wherein the usage method information includes information indicating a ratio of a current charge amount with respect to full charge capacity of the battery at which charging of the battery should be started.

Further features of the present invention will become apparent from the following description of exemplary embodiments with reference to the attached drawings.

### BRIEF DESCRIPTION OF THE DRAWINGS

FIG. 1 is a block diagram illustrating a configuration example of an assistance system.

FIG. 2 is a flowchart illustrating assistance processing according to a first embodiment.

FIG. 3 is a diagram illustrating an example of an initial screen.

FIG. 4 is a diagram for illustrating assistance processing according to the first embodiment.

FIG. 5 is a diagram illustrating an example of a screen for notifying a transaction price of a battery.

FIG. 6 is a flowchart illustrating assistance processing according to a second embodiment.

FIG. 7 is a diagram for illustrating assistance processing according to the second embodiment.

FIG. 8 is a diagram illustrating an example of the screen for notifying the transaction price of the battery.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

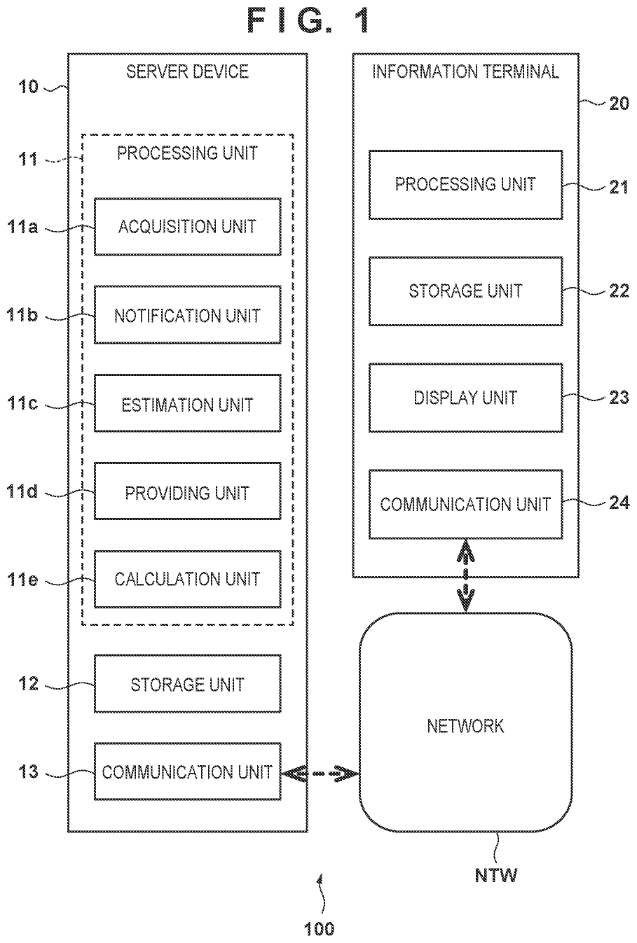

Hereinafter, a first embodiment according to the present invention will be described. FIG. 1 is a block diagram illustrating a configuration example of an assistance system 100 according to the present embodiment. The assistance system 100 includes a server device 10 and an information terminal 20 communicably connected to each other via a network. In the present embodiment, an example of assisting with reuse of an in-vehicle battery used in a vehicle will be described, and an in-vehicle device will be exemplified as the information terminal 20, but the present invention is not limited thereto, and the information terminal 20 may be, for example, a smartphone, a tablet terminal, a personal computer, or the like.

First, a configuration example of the server device 10 will be described. The server device 10 includes, for example, a computer, and can include a processing unit 11, a storage unit 12 (database), and a communication unit 13. The processing unit 11 includes a processor represented by the CPU, a storage device such as a semiconductor memory or the like, an interface with an external device, and the like. The storage unit 12 stores a program to be executed by the processor, data to be used for processing by the processor, and the like. The processing unit 11 can read the program stored in the storage unit 12 to the storage device such as a memory and execute the program. In the case of the present embodiment, the storage unit 12 stores a program (assistance program) for assisting with reuse of the battery owned by the user of the information terminal 20, and the processing unit 11 can read the assistance program stored in the storage unit 12 into a storage device such as a memory and execute the program. Furthermore, the communication unit 13 is a unit for communicating with the information terminal 20 via the network NTW.

Furthermore, the processing unit 11 of the present embodiment can be provided with an acquisition unit 11a, a notification unit 11b, an estimation unit 11c, a providing unit 11d, and a calculation unit 11e. The acquisition unit 11a acquires information on the battery to be sold from the user (information terminal 20). The notification unit 11b notifies the user (information terminal 20) of information such as the transaction price of the battery. The estimation unit 11c estimates the deterioration state of the battery at the scheduled sale timing based on the information on the battery acquired by the acquisition unit 11a. The providing unit 11d provides the user (information terminal 20) with information regarding a method for using the battery. In addition, the calculation unit 11e calculates the transaction price of the battery at the scheduled sale timing based on the information on the battery acquired by the acquisition unit 11a. Note that the calculation unit 11e can be used in a second embodiment.

Next, a configuration example of the information terminal 20 will be described. The information terminal 20 may include, for example, a processing unit 21, a storage unit 22, a display unit 23, and a communication unit 24. The processing unit 21 includes a processor represented by the CPU, a storage device such as a semiconductor memory, an interface with an external device, and the like. The processing unit 21 may be configured as a part of an electronic control unit (ECU) that controls each unit of the vehicle, and can control charging and discharging of a battery (in-vehicle battery) and manage (monitor or measure) a deterioration state of the battery. The storage unit 22 stores a program, data, and the like for controlling the information terminal 20, and the processing unit 21 can read the program stored in the storage unit 22 into a storage device such as a memory and execute the program. Furthermore, the display unit 23 may include a display that displays information acquired from the server device 10. The display unit 23 may be a display provided in a car navigation system, and includes, for example, a touch panel liquid crystal display (LCD) or the like, and has a function as an input unit that receives an instruction from the user in addition to a function of displaying information (image). The communication unit 24 is a unit for communicating with the server device 10 via a network NTW.

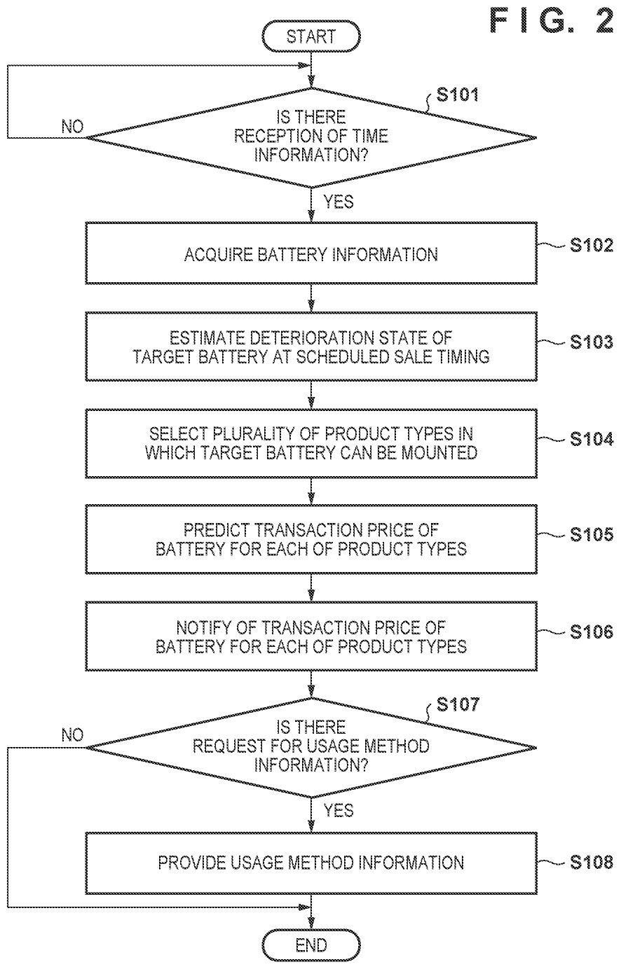

FIG. 2 is a flowchart illustrating assistance processing for assisting with battery reuse. The flowchart illustrated in FIG. 2 can be performed by the processing unit 11 of the server device 10 when the assistance program is executed. In the present embodiment, an example of notifying a user of an estimated price (market price) of a general battery traded in the market at the scheduled sale timing of a battery owned by the user will be described. Note that, in the following description, the term “target battery” refers to a battery owned by the user and to be sold, and the term “battery” simply refers to a general battery (which may include the target battery).

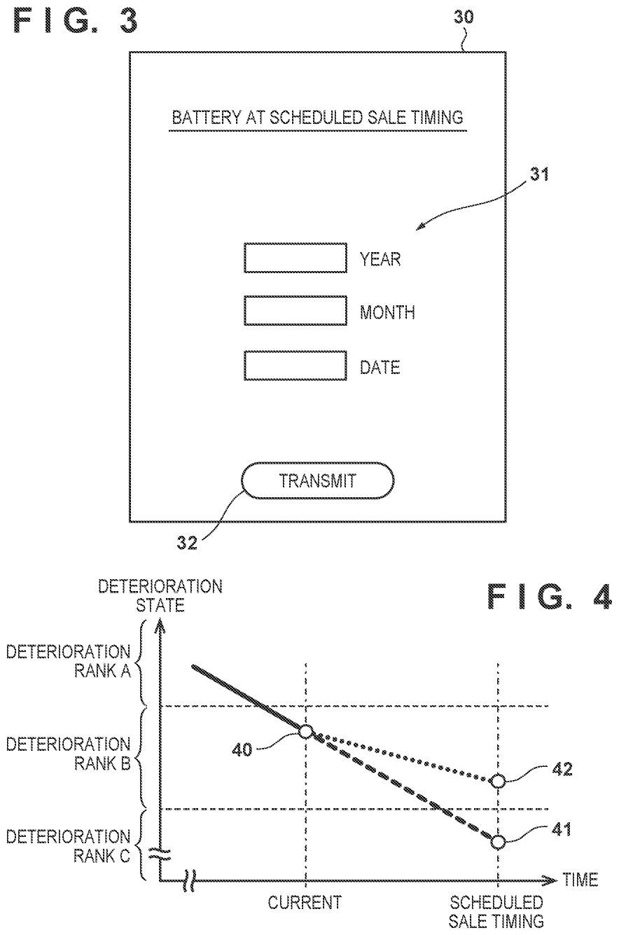

In S101, the processing unit 11 determines whether time information indicating the scheduled sale timing of the target battery has been received from the information terminal 20 (user). For example, in an initial screen 30 displayed on the display unit 23 as illustrated in FIG. 3, in a case where the user inputs the scheduled sale timing of the target battery in an input field 31 and touches (presses) a send button 32 on the screen, the information terminal 20 transmits the time information indicating the scheduled sale timing to the server device 10 via the network NTW. As a result, the processing unit 11 of the server device 10 can determine whether the time information has been received from the information terminal 20. In a case where the time information has not been received, process in S101 is repeated, and in a case where the time information has been received, the process proceeds to S102.

In S102, the processing unit 11 (acquisition unit 11a) acquires the battery information from the information terminal 20 (user). The battery information may include characteristic information indicating characteristics of the target battery in addition to the time information received in S101. The characteristic information includes information indicating a current state of health (SOH) of the target battery, but may include, for example, information such as a state of charge (SOC), an initial full charge capacity, a battery model/shape, and the number of times of charging and discharging of the battery. The SOH is an index representing a deterioration state (degree of deterioration) of the battery, and can be represented by full charge capacity (Ah) at the time of deterioration/initial full charge capacity (Ah)×100. In addition, the SOC is an index representing a charge state of the battery, and can be represented by remaining capacity (Ah)/full charge capacity (Ah)×100.

In S103, the processing unit 11 (estimation unit 11c) estimates the deterioration state of the target battery at the scheduled sale timing based on the battery information acquired in S102. For example, as illustrated in FIG. 4, the processing unit 11 can estimate (calculate) a deterioration state 41 of the target battery at the scheduled sale timing based on a current deterioration state (SOH) 40 of the target battery acquired in S102 as battery information and the temporal degradation rate (inclination) of the target battery so far. The temporal degradation rate of the target battery is a change over time in a deterioration state of the target battery. The processing unit 11 may use, as the temporal degradation rate of the target battery, a change in the deterioration state (SOH) of the target battery periodically measured by the information terminal 20 so far or a temporal degradation rate (for example, a specification value) normally obtained in a battery of the same type as the target battery.

In S104, the processing unit 11 selects a plurality of product types in which the target battery can be mounted based on the battery information acquired in S102. For example, the storage unit 12 (database) of the server device 10 stores information (hereinafter, it may be referred to as product information) indicating a correspondence relationship between various product types and the type and shape of the battery mounted in each of the product types. The processing unit 11 can select (determine) a plurality of product types in which the target battery can be mounted from the product information stored in the storage unit 12 based on the information regarding the type and shape of the target battery acquired in S102.

In S105, the processing unit 11 predicts (determines) the transaction price of a general battery at the scheduled sale timing for each of the plurality of product types selected in S104. For example, the storage unit 12 (database) of the server device 10 stores data indicating transition (fluctuation) of a general battery price traded in the market in the past for each of various product types. As a result, the processing unit 11 acquires data indicating the transition of the price of a general battery in the past several years from the storage unit 12, and can predict (determine) the general battery price at the scheduled sale timing as the transaction price based on the data. As described above, the general prediction of the battery price at the scheduled sale timing can be performed for each of the plurality of product types selected in S104.

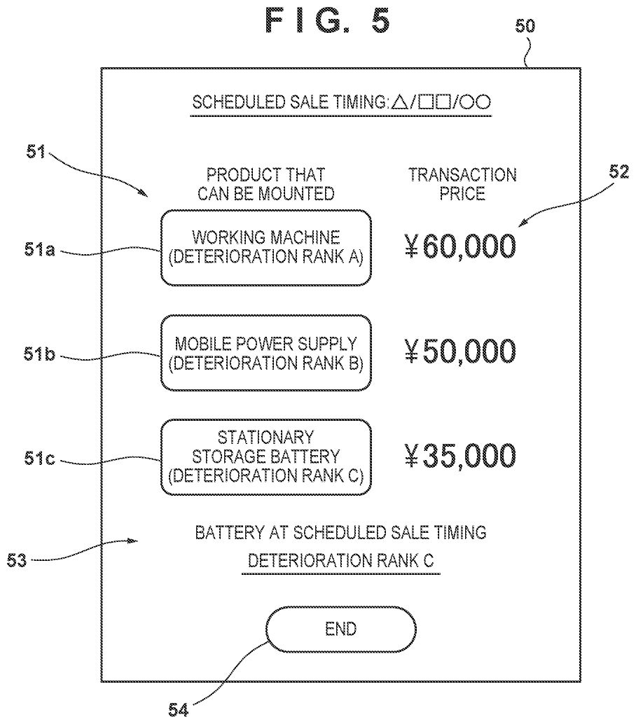

In S106, the processing unit 11 (notification unit 11b) notifies the information terminal 20 (user) of the transaction price of the general battery at the scheduled sale timing determined in S105 for each of the plurality of product types selected in S104. For example, the processing unit 11 transmits information in which each of the plurality of product types is associated with the transaction price of a general battery at the scheduled sale timing to the information terminal 20 via the network NTW. As illustrated in FIG. 5, the information terminal 20 that has received the information displays a screen for notifying the transaction price of the battery at the scheduled sale timing for each product type on the display unit 23. FIG. 5 illustrates an example of a screen displayed on the display unit 23 of the information terminal 20. A screen 50 illustrated in FIG. 5 includes a display 51 of a product type on which the target battery can be mounted, a display 52 of a transaction price of a general battery at the scheduled sale timing, a display 53 indicating a deterioration state of the target battery at the scheduled sale timing, and an end button 54 for giving an end instruction of the assisting processing. In addition, in FIG. 5, a working machine (deterioration rank A), a mobile power supply (deterioration rank B), and a stationary storage battery (deterioration rank C) are illustrated as product types. The deterioration rank indicates a range of a deterioration state of a reusable battery for each product type, and a deterioration degree of the battery is greater in the deterioration rank B than in the deterioration rank A, and the deterioration degree of the battery is greater in the deterioration rank C than in the deterioration rank B.

In addition, in S106, the processing unit 11 (notification unit 11b) may notify the information terminal 20 (user) of a corresponding product type as a reuse destination of the target battery among the plurality of product types selected in S104 based on the deterioration state of the target battery estimated in S103. For example, as illustrated in FIG. 4, the processing unit 11 estimates a deterioration rank (deterioration rank C in FIG. 4) corresponding to the target battery at the scheduled sale timing from the deterioration state 41 of the target battery at the scheduled sale timing estimated in S103. Then, the information on the deterioration rank estimated in this way (that is, information on the product type corresponding to the reuse destination of the target battery) is transmitted to the information terminal 20 via the network NTW. The information terminal 20 that has received the information displays the deterioration rank of the target battery at the scheduled sale timing as in the display 53 of the screen 50 in FIG. 5. As a result, the user can recognize (know) the product type corresponding to the reuse destination of the target battery at the scheduled sale timing among the plurality of product types (working machine, mobile power supply, or stationary storage battery) displayed on the screen 50.

In S107, the processing unit 11 determines whether there is a request for information (hereinafter, it may be referred to as usage method information) on a method for using the target battery while reducing the deterioration of the target battery until the scheduled sale timing. For example, on the screen 50 illustrated in FIG. 5, the displays 51a to 51c of the respective product types are selection buttons, and the user can select a target product type as a reuse destination of the target battery by touching (pressing) one of the displays 51a to 51c on the screen. In a case where any one of the product type displays 51a to 51c is touched on the screen by the user, it is determined that there is a request for the usage method information of the target battery, and the process proceeds to S108. On the other hand, in a case where the end button 54 is touched on the screen by the user, it is determined that there is no request for the usage method information of the target battery, and the assistance processing is ended.

In S108, the processing unit 11 (providing unit 11d) provides the information terminal 20 (user) with the usage method information of the target battery. For example, in a case where the user touches and selects one of the product type displays 51a to 51c on the screen 50 illustrated in FIG. 5, the processing unit 11 provides (transmits) the usage method information for reducing the deterioration of the target battery with the product type selected by the user as a target to the information terminal 20 (user). As an example, it is assumed that the user touches and selects the display 51b of the mobile power supply (deterioration rank B) on the screen 50 illustrated in FIG. 5. In this case, as illustrated in FIG. 4, the processing unit 11 provides the information terminal 20 (user) with the usage method information for setting the deterioration state of the target battery at the scheduled sale timing within the range of the deterioration rank B (that is, a deterioration state 42 is set).

The usage method information may include information on the use condition of the target battery, for example, a target charge amount of the battery, a charging speed of the battery, a charging frequency of the battery, and the like. As an example, the usage method information may include use conditions such as setting a target charge amount of the battery to a predetermined ratio (for example, 80%) of the full charge capacity, specifying a charging method (charging speed) of the battery, and charging when the charge amount of the battery becomes equal to or less than a predetermined ratio (for example, 20%) of the full charge capacity. The usage method information is preferably generated (set) such that the usage condition of the target battery imposed on the user becomes stricter as the difference between the deterioration state 41 of the target battery estimated in S103 and the target deterioration rank (deterioration state 42) is greater.

As described above, in the assistance system 100 of the present embodiment, the server device 10 acquires the time information indicating the scheduled sale timing of the target battery from the information terminal 20 (user), and notifies the information terminal 20 (user) of the transaction price of the target battery in the scheduled sale timing for each product type on which the target battery can be mounted based on the time information. As a result, the user can know the transaction price of the target battery at the scheduled sale timing of the target battery.

### Second Embodiment

Hereinafter, a second embodiment according to the present invention will be described. In the present embodiment, an example of notifying the user of the price determined (calculated) according to the deterioration state of the target battery at the scheduled sale timing will be described. Note that the present embodiment basically takes over the first embodiment, and configurations and the like of the assistance system 100, the server device 10, and the information terminal 20 are similar to those of the first embodiment unless otherwise mentioned below.

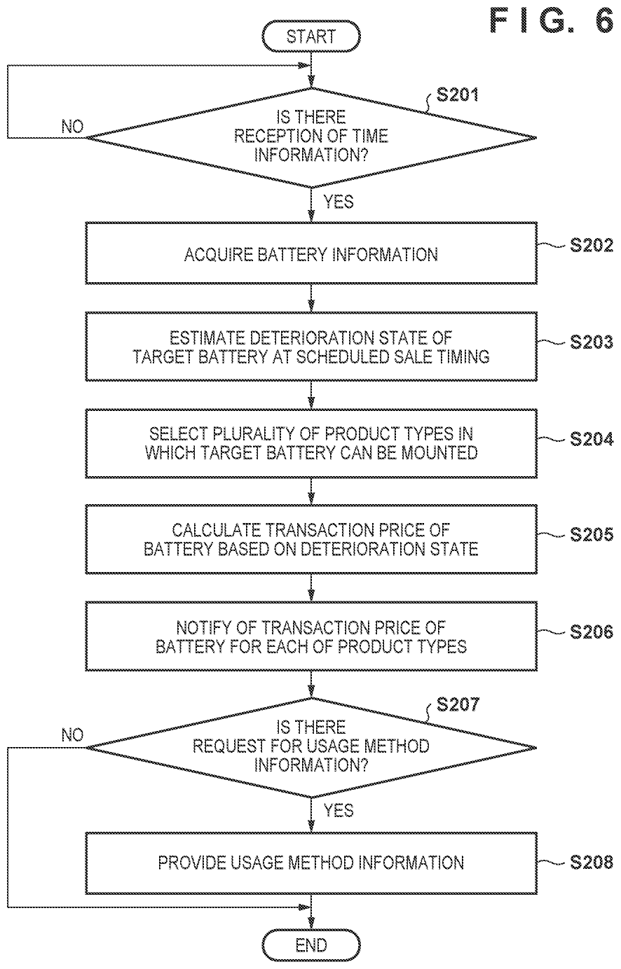

FIG. 6 is a flowchart illustrating assistance processing for assisting with battery reuse in the present embodiment. The flowchart illustrated in FIG. 6 can be performed by the processing unit 11 of the server device 10 when the assistance program is executed. Further, steps S201 to S204 in the flowchart illustrated in FIG. 6 are processes similar to steps S101 to S104 in the flowchart illustrated in FIG. 2 described in the first embodiment, respectively, and thus description thereof is omitted here.

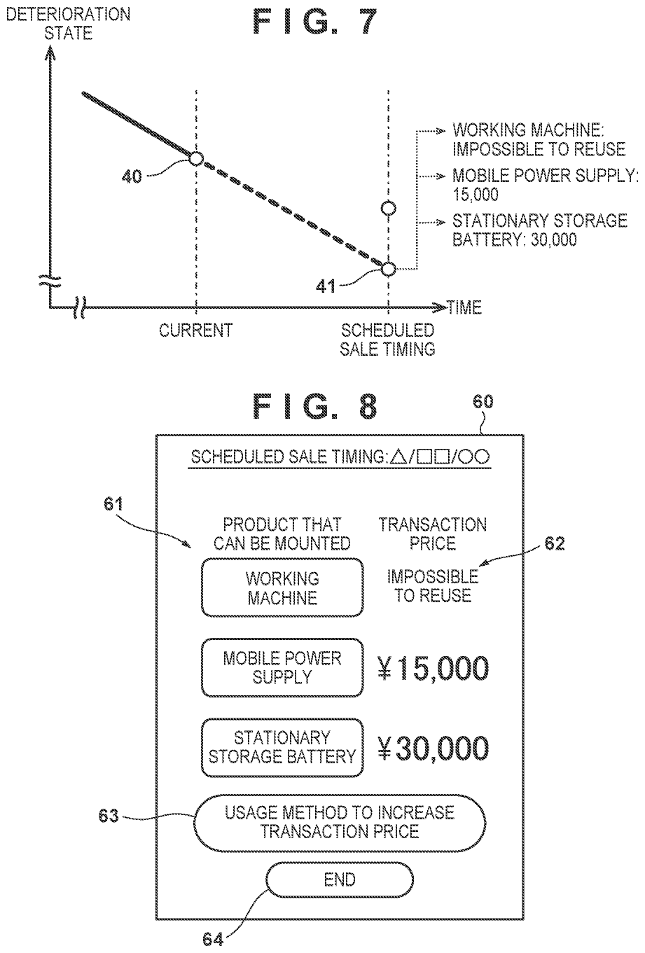

In S205, the processing unit 11 (calculation unit 11e) calculates, for each of the plurality of product types selected in S204, the transaction price of the target battery in the scheduled sale timing based on the deterioration state of the target battery in the scheduled sale timing estimated in S203. For example, the storage unit 12 (database) of the server device 10 stores data indicating a correspondence relationship between a deterioration state and a price of a general battery traded in the market in the past for each of various product types. As a result, as illustrated in FIG. 7, the processing unit 11 can calculate (predict) the transaction price of the target battery in the scheduled sale timing from the data stored in the storage unit 12 based on the deterioration state 41 of the target battery in the scheduled sale timing estimated in S203. The transaction price of the target battery can be calculated for each of the plurality of product types selected in S204. In FIG. 7, a working machine, a mobile power supply, and a stationary storage battery are illustrated as product types, and a transaction price calculated when the target battery in the deterioration state 41 estimated in S203 is reused for each product type is illustrated. For the working machine, it is indicated that the target battery cannot be reused in the deterioration state 41 estimated in S203.

In S206, the processing unit 11 (notification unit 11b) notifies the information terminal 20 (user) of the transaction price of the target battery calculated in S205 for each of the plurality of product types selected in S204. For example, the processing unit 11 transmits information in which each of the plurality of product types is associated with the transaction price of the target battery calculated in S205 to the information terminal 20 via the network NTW. As illustrated in FIG. 8, the information terminal 20 that has received the information displays a screen for notifying the transaction price of the target battery at the scheduled sale timing for each product type on the display unit 23. FIG. 8 illustrates an example of a screen displayed on the display unit 23 of the information terminal 20. A screen 60 illustrated in FIG. 8 includes a display 61 of the product type on which the target battery can be mounted, a display 62 of the transaction price of the target battery at the scheduled sale timing calculated in S205, a request button 63 for requesting usage method information of the target battery, and an end button 64 for giving an end instruction of the assistance processing.

In S207, the processing unit 11 determines whether there is a request for usage method information of the target battery for increasing the transaction price of the target battery. The usage method information of the present embodiment is information related to a usage method of the target battery while reducing the deterioration of the target battery until the scheduled sale timing and increasing the transaction price of the target battery at the scheduled sale timing. As described in the first embodiment, the usage method information may include information on the use condition of the target battery, for example, a target charge amount of the battery, a charging speed of the battery, a charging frequency of the battery, and the like. In a case where the request button 63 is touched on the screen by the user, it is determined that there is a request for the usage method information of the target battery, the processing proceeds to S108, and the usage method information of the target battery is provided to the information terminal 20 (user). On the other hand, in a case where the end button 64 is touched on the screen by the user, it is determined that there is no request for the usage method information of the target battery, and the assistance processing is ended.

As described above, in the assistance system 100 of the present embodiment, the server device 10 calculates the transaction price of the target battery at the scheduled sale timing for each product type on which the target battery can be mounted, and notifies the information terminal 20 (user) of the transaction price. As a result, the user can know the transaction price of the target battery at the scheduled sale timing of the target battery.

### Third Embodiment

In the above embodiment, the processing unit 11 (notification unit 11b) of the server device 10 may notify the user (information terminal 20) of a recommended sale timing of the target battery. For example, in the example illustrated in FIG. 4, the processing unit 11 may estimate the time at which the deterioration rank of the target battery changes (as an example, the time when the deterioration rank B changes to the deterioration rank C) based on the deterioration state (SOH) 40 of the target battery acquired as the battery information and the temporal degradation rate (inclination) of the target battery so far, and notify the user of the estimated time as the recommended sale timing. In addition, in a case where the target battery is reused (reusable conversion) for another device owned by the user, the processing unit 11 may acquire information regarding the reuse destination device from the user (information terminal 20) in advance and notify the user of the time when the target battery can be reused for the device as the recommended sale timing. The “time when the target battery is reusable for the device” may be, for example, a time when the deterioration state of the target battery falls within the range of the deterioration rank of the battery applicable to the device.

In addition, in a case where the transaction price of the target battery at the scheduled sale timing is predicted to be lower than that of the notified transaction price, the processing unit 11 of the server device 10 may notify of a proposal to sell the target battery early according to the use mode of the target battery by the user. For example, the processing unit 11 periodically acquires the battery information of the target battery by the user (information terminal 20), and notifies of a proposal to sell the target battery early in a case where the transaction price of the target battery (transaction price at the scheduled sale timing) is predicted to be low based on the acquired battery information. As an example, the processing unit 11 may notify the user of the time when the deterioration state of the target battery falls within the deterioration rank of the product type selected in S107 of the flowchart illustrated in FIG. 2 as the recommended sale timing.

### Other Embodiments

In the above embodiment, the server device 10 may include a plurality of processing modes for executing the assistance processing, and may be configured to execute the assistance processing in a processing mode selected by the user among the plurality of processing modes. The plurality of processing modes may include a first processing mode for notifying the user of a general battery price at the scheduled sale timing as described in the first embodiment, and a second processing mode for notifying the user of a price of the target battery calculated based on the deterioration state at the scheduled sale timing as described in the second embodiment.

In the above embodiment, the example in which the server device 10 performs the assistance processing for assisting the reuse of the target battery has been described, but the present invention is not limited thereto, and the information terminal 20 (for example, an in-vehicle device) may perform the assistance processing. In this case, preferably, the function of the server device 10 is provided to the information terminal 20 (processing unit 21), and the assistance program, various types of information, and various types of data are stored in the storage unit 22.

### Summary of Embodiments

1. The assistance system of the above embodiments is an assistance system (for example, 100) for assisting with battery reuse, the system comprising:

acquisition means (for example, 11a) for acquiring time information indicating a scheduled sale timing of the battery from a user of the battery; and

notification means (for example, 11b) for notifying the user of a transaction price of the battery at the scheduled sale timing for each of a plurality of product types (for example, 51) in which the battery is mountable based on the time information acquired by the acquisition means.

According to this embodiment, it is possible to realize a desire of a user to know what type of product the battery to be sold can be mounted in and to know the transaction price at the scheduled sale timing.

2. In the assistance system of the above embodiments,

the notification means notifies the user of a general battery price traded in a market at the scheduled sale timing, as the transaction price, for each of the plurality of product types.

According to this embodiment, the user can know the market price of the battery to be sold at the scheduled sale timing.

3. In the assistance system of the above embodiments,

the system further comprises estimation means (for example, 11c) for estimating a deterioration state of the battery at the scheduled sale timing, wherein

the notification means notifies the user of a product type corresponding to a reuse destination of the battery among the plurality of product types based on the deterioration state estimated by the estimation means.

According to the present embodiment, in a case where the battery is used in the use mode as it is, the user can know which product type corresponds to the reuse destination of the battery.

4. In the assistance system of the above embodiments,

the system further comprises providing means (for example, 11d) for providing the user with information on a usage method of the battery for reducing deterioration of the battery until the scheduled sale timing.

According to the present embodiment, a user can learn how to use the battery to improve a deterioration state of a battery at the scheduled sale timing and sell the battery at a high price.

5. In the assistance system of the above embodiments,

the providing means provides the user with the information on the usage method of the battery for reducing deterioration of the battery with a product type selected by the user among the plurality of product types as a target.

According to the present embodiment, the user can know how to use the battery to improve the deterioration state of the battery at the scheduled sale timing and sell the battery at a high price toward a desired product type (that is, the transaction price).

6. In the assistance system of the above embodiments,

the notification means notifies the user of a price calculated according to a deterioration state of the battery at the scheduled sale timing as the transaction price for each of the plurality of product types.

According to the present embodiment, the user can know the transaction price when each of a plurality of product types is set as a reuse destination for the battery to be sold.

7. In the assistance system of the above embodiments,

the system further comprises:

estimation means (for example, 11c) for estimating a deterioration state of the battery at the scheduled sale timing; and

calculation means (for example, 11e) for calculating the transaction price for each of the plurality of product types, based on the deterioration state of the battery estimated by the estimation means,

wherein the notification means notifies the user of the transaction price calculated by the calculation means for each of the plurality of product types.

According to the present embodiment, the user can know the transaction price when each of a plurality of product types is set as a reuse destination for the battery to be sold.

8. In the assistance system of the above embodiments,

the system further comprises providing means (for example, 11d) for providing the user with information on a method for using the battery that will raise the transaction price.

According to the present embodiment, it is possible to learn how to use the battery to improve a deterioration state of a battery at the scheduled sale timing and sell the battery at a high price.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An assistance system for assisting with battery reuse, comprising:
an acquisition unit configured to acquire, from a user of the battery, time information indicating a scheduled sale timing of the battery, and model information indicating a model and a shape of the battery;
a selection unit configured to select a plurality of product types in which the battery can be mounted, based on the model information acquired by the acquisition unit;
a notification unit configured to notify the user of a transaction price of the battery at the scheduled sale timing, for each of the plurality of product types selected by the selection unit, based on the time information acquired by the acquisition unit; and
a providing unit configured to provide the user with usage method information on a usage method of the battery for reducing deterioration of the battery until the scheduled sale timing, with a product type selected among the plurality of product types by the user in response to notification of the transaction price by the notification unit as a target of a reuse destination,
wherein the usage method information includes information indicating a ratio of a current charge amount with respect to full charge capacity of the battery at which charging of the battery should be started.

2. The assistance system according to claim 1, wherein the notification unit is configured to notify the user of a general battery price traded in a market at the scheduled sale timing, as the transaction price, for each of the plurality of product types.

3. The assistance system according to claim 2, further comprising an estimation unit configured to estimate a deterioration state of the battery at the scheduled sale timing,
wherein the notification unit is configured to notify the user of a product type corresponding to a reuse destination of the battery among the plurality of product types, based on the deterioration state estimated by the estimation unit.

4. The assistance system according to claim 1, wherein the usage method information includes information indicating a charging speed of the battery.

5. The assistance system according to claim 1, wherein the usage method information includes information indicating a ratio of a target charge amount with respect to the full charge capacity of the battery.

6. The assistance system according to claim 1, wherein the notification unit is configured to notify the user of a price calculated according to a deterioration state of the battery at the scheduled sale timing, as the transaction price, for each of the plurality of product types.

7. The assistance system according to claim 6, further comprising:
an estimation unit configured to estimate a deterioration state of the battery at the scheduled sale timing; and
a calculation unit configured to calculate the transaction price for each of the plurality of product types, based on the deterioration state of the battery estimated by the estimation unit,
wherein the notification unit is configured to notify the user of the transaction price calculated by the calculation unit for each of the plurality of product types.

8. The assistance system according to claim 6, further comprising a providing unit configured to provide the user with information on a method for using the battery that will raise the transaction price.

9. The assistance system according to claim 1, wherein the notification unit is configured to notify the user of a range of a deterioration state of a reusable battery for each of the plurality of product types selected by the selection unit.

10. The assistance system according to claim 1, further comprising an estimation unit configured to estimate a deterioration state of the battery at the scheduled sale timing,
wherein the notification unit is configured to notify the user of the estimated deterioration state of the battery at the scheduled sale timing.

11. The assistance system according to claim 10, wherein
the acquisition unit is configured to acquire first information indicating a current deterioration state of the battery, and second information indicating a temporal degradation rate of the battery so far, and
the estimation unit is configured to estimate a deterioration state of the battery at the scheduled sale timing, based on the first information and the second information acquired by the acquisition unit.

12. A non-transitory computer-readable storage medium storing a program for causing a computer to function as an assistance system according to claim 1.

13. An assistance method for assisting with battery reuse, comprising:
acquiring, from a user of the battery, time information indicating a scheduled sale timing of the battery from a user of the battery, and model information indicating a model and a shape of the battery;
selecting a plurality of product types in which the battery can be mounted, based on the acquired model information;
notifying the user of a transaction price of the battery at the scheduled sale timing, for each of the selected plurality of product types, based on the acquired time information; and
providing the user with usage method information on a usage method of the battery for reducing deterioration of the battery until the scheduled sale timing, with a product type selected among the plurality of product types by the user in response to notification of the transaction price by the notifying as a target of a reuse destination,
wherein the usage method information includes information indicating a ratio of a current charge amount with respect to full charge capacity of the battery at which charging of the battery should be started.

14. A server device for assisting with battery reuse, comprising:
an acquisition unit configured to acquire, from a user of the battery, time information indicating a scheduled sale timing of the battery, and model information indicating a model and a shape of the battery;
a selection unit configured to select a plurality of product types in which the battery can be mounted, based on the model information acquired by the acquisition unit;
a notification unit configured to notify the user of a transaction price of the battery at the scheduled sale timing, for each of the plurality of product types selected by the selection unit, based on the time information acquired by the acquisition unit; and
a providing unit configured to provide the user with usage method information on a usage method of the battery for reducing deterioration of the battery until the scheduled sale timing, with a product type selected among the plurality of product types by the user in response to notification of the transaction price by the notification unit as a target of a reuse destination,
wherein the usage method information includes information indicating a ratio of a current charge amount with respect to full charge capacity of the battery at which charging of the battery should be started.
